(19) United States
(12) Patent Application Publication
(10) Pub. No.: US 2005/0043186 A1
(43) Pub. Date: Feb. 24, 2005

(54) Method for forming pattern and drop discharge apparatus

(75) Inventors: Shinji Maekawa, Atsugi (JP); Shunpei Yamazaki, Tokyo (JP)

Correspondence Address: COOK, ALEX, McFARRON, MANZO,;CUMMINGS & MEHLER, LTD., SUITE 2850, 200 WEST ADAMS STREET, CHICAGO, IL, 60606, US

(73) Assignee: Semiconductor Energy Laboratory Co., Ltd.

(21) Appl. No.: 10/827,457

(22) Filed: Apr. 19, 2004

(30) Foreign Application Priority Data
Apr. 25, 2003 (JP) 2003-120949

(51) Int. Cl. C01F 1/00

(52) U.S. Cl. 505/741

(57) ABSTRACT

The present invention is characterized in having a process for forming a pattern by making a substrate having an insulating property, such as a liquid-repellent thin film over a substrate, such as a semiconductor film, selectively have affinity for liquid by plasma generating means 102, and discharging a drop compound to the surface having affinity for liquid by a drop discharging means 103. By putting the region having affinity for liquid, which was selectively formed, between liquid-repellent, a drop after drop landing can be formed without moving the drop landing portion

### TECHNICAL FIELD

This invention relates to a method for forming a film pattern and a drop discharge apparatus.

### BACKGROUND ART

Recently, development of methods for forming patterns using a drop discharge method based on screen printing or ink jet has been actively carried out.

Since the drop discharge method has many advantages including need for no masks because of its patterning by direct plotting, easy application of the method to a large substrate, high material use efficiency and the like, use of fine patterning for FPDs (flat panel displays) has become popular.

As applications of the method, formation of not only light-emitting layers of organic EL (electroluminescence) and color filters of LCDs (liquid crystal displays) but also electrodes and organic transistors of PDPs (plasma display devices) has been reported.

### DISCLOSURE OF THE INVENTION

(Problems to be Solved by the Invention)

While the drop discharge method has many advantages, there are various limitations on drops containing compositions and substrates for actually performing fine patterning.

A drop that can be formed at present has at least a size of approximately 2 pL and such a fine drop is arranged accurately on a substrate to form a pixel, electrode, wiring or the like. However, the actual drop landing accuracy is approximately some μm to 30 μm, and even after the landing, the drop may be affected by the state of the surface where the drop landed and the contact angle of the drop and thus may deviate from the landing position. Therefore, it is often insufficient as patterning for forming a pixel part of a small FPD.

Therefore, in the case of a light-emitting layer of an organic EL or a color filter, a drop is discharged within a bank formed by a photolithography technique in order to avoid deviation of the landing position.

In the drop discharge method, needless to say, a head and a drop containing a composition are the most important elements, but the other elements are actually influential, too. Unlike ordinary ink jet in which an absorbent medium such as paper takes ink, in most FPD applications, a drop must be discharged onto a non-absorbent substrate, generating a restraint to the discharge method. For example, since a drop is discharged onto a substrate having affinity for liquid, the drop largely expands thereon. Therefore, a substrate on which fine patterning is to be performed must be liquid-repellent to a certain degree. However, since a drop put on a liquid-repellent substrate easily moves, a combination of the surface state of the substrate and the discharge conditions must be optimized before plotting.

Thus, it is an object of this invention to provide a pattern formation method with improved position accuracy at the time of drop landing on a substrate. It is another object of this invention to provide a drop discharge apparatus with improved position accuracy.

(Means for Solving the Problems)

This invention provides a method for forming a pattern with improved position accuracy at the time of drop landing on a substrate and a drop discharge apparatus of a structure having plasma generating means.

That is, this invention is characterized by including a step of providing affinity for liquid by means for selectively generating plasma on a liquid-repellent thin film, for example, a semiconductor film, on a substrate having insulating property, for example, a glass substrate, and discharging a drop composition onto the surface having affinity for liquid by drop discharge means, thus forming a pattern. As the selectively formed region having affinity for liquid is provided between liquid-repellent parts, a drop can be formed without moving from its landing position after landing. As a power source for plasma generation, a high-voltage pulse power source constructed to apply a high-frequency or pulsed electric field is used. It is preferred that a high-frequency is in a frequency of 10 MHz to 100 MHz, the frequency of the pulse power source is 50 Hz to 100 kHz, and the pulse duration is 1 to 100 μsec. The pressure is atmospheric pressure or within a range close to atmospheric pressure, and the range of pressure may be 1.3×10¹ to 1.31×10⁵ Pa. As a reactive gas, one or plural gases of inert gases such as He, Ne, Ar, Kr and Xe, and oxygen and nitrogen may be properly selected and used. Affinity for liquid is defined as 0°≦θ<10°, where θ represents contact angle, and liquid-repellence is defined as 10°≦θ<180°.

This invention is characterized by including a step of selectively forming a groove by means for selectively generating plasma on a thin film having affinity for liquid, for example, silicon oxide film, on a substrate having insulating property, for example, a glass substrate, and discharging a drop composition onto the surface having affinity for liquid by drop discharge means, thus forming a pattern. As a groove is selectively formed on the surface having affinity for liquid, a drop can be formed without moving from its landing position after landing. As a power source for plasma generation, a high-frequency power source or high-voltage pulse power source is used. It is preferred that a high-frequency is in a frequency of 10 MHz to 100 MHz, the frequency of the pulse power source is 50 Hz to 100 kHz, and the pulse duration is 1 to 100 μsec. The pressure is atmospheric pressure or within a range close to atmospheric pressure, and the range of pressure may be 1.3×10¹ to 1.31×10⁵ Pa. As a reactive gas, a reducing gas such as hydrogen or a gas such as CF₄, CHF₃ or SF₆ may be used for etching so that a groove can be selectively formed. Affinity for liquid is defined as 0°≦θ<10°, where 0 represents contact angle, and liquid-repellence is defined as 10°≦θ<180°.

This invention also provides drop discharge means with a structure having plasma processing means, and with this structure, this invention can provide a drop discharge apparatus with improved position accuracy at the time of drop landing.

The drop discharge method in this invention refers to a method of forming a predetermined pattern by discharging a drop containing a predetermined composition from a fine hole, and an ink jet method or the like is included in this category.

(Effect of the Invention)

According to this invention, with the above-described structure, a pattern can be formed with improved position accuracy at the time of drop composition's landing on a substrate. Moreover, reduction in process steps, improvement in yield and rise in material use efficiency due to direct plotting enable preparation of a display apparatus that is adapted to the earth environment and enables significant reduction in cost.

### BRIEF DESCRIPTION OF THE DRAWINGS

FIG. 1 is a view showing the structure of means for selectively forming a region having affinity for liquid on a liquid-repellent surface.

FIG. 2 is a view showing the structure of means for selective forming a groove on a surface having affinity for liquid.

FIG. 3 is a conceptual view of a plasma processing region and a drop diameter at the time of landing.

FIG. 4 is a view showing an example of pattern plotting means according to this invention.

FIG. 5 is a view showing an example of pattern plotting means according to this invention.

FIG. 6 is a view showing a plasma processing port and a drop discharge port.

FIG. 7 is a view showing an example of plotting means according to this invention.

FIG. 8 is a sectional view for explaining a process of manufacturing a display apparatus in this invention.

FIG. 9 is a sectional view for explaining the process of manufacturing a display apparatus in this invention.

FIG. 10 is a sectional view for explaining the process of manufacturing a display apparatus in this invention.

FIG. 11 is a sectional view for explaining the process of manufacturing a display apparatus in this invention.

FIG. 12 is a view showing the process of manufacturing a display apparatus according to this invention.

FIG. 13 is a view showing an embodiment of the display apparatus in this invention.

FIG. 14 is a view showing an example of means for filling an opening with a drop composition according to this invention.

FIG. 15 is a view showing an example of means for filling an opening with a drop composition according to this invention.

FIG. 16 is a view showing an example of means for filling an opening with a drop composition according to this invention.

FIG. 17 is a view showing an example of control device in this invention.

### BEST MODE FOR CARRYING OUT THE INVENTION

Hereinafter, embodiments of this invention will be described in detail with reference to the drawings. However, this invention is not limited to the following description and those skilled in the art can easily understand that the mode and details of the invention can be easily changed without departing from the point and scope of this invention. Therefore, this invention should not be interpreted as being limited to the following description of the embodiments. In the structure of this invention that will be described hereinafter, reference numerals and signs denoting the same elements are commonly used in the different drawings.

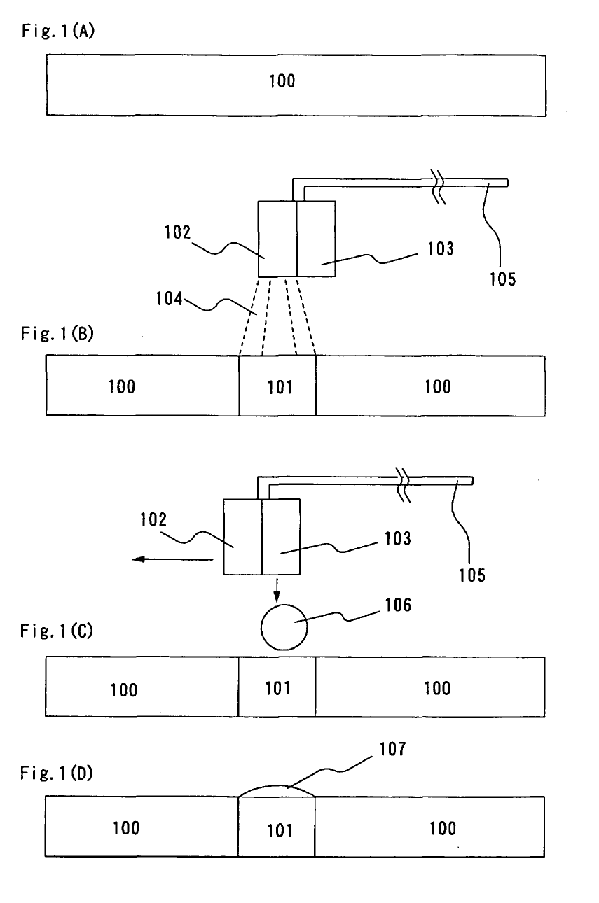

An embodiment of drop discharge means according to this invention that selectively forms a region having affinity for liquid on a liquid-repellent surface will be described with reference to FIG. 1. A thin film 100 having a liquid-repellent surface, for example, a semiconductor silicon film, is formed on a substrate having insulating property, for example, a glass substrate (FIG. 1(A)). Plasma is selectively irradiated to a drop discharge-scheduled region 101 on the surface of the thin film 100 by plasma irradiating means 102, thus causing the region 101 to have affinity for liquid (FIG. 1(B)). On the surface having affinity for liquid thus formed, a drop composition 106 is discharged by drop discharge means 103 to form a pattern (FIG. 1(C)(D)). The plasma irradiating means 102 and the drop discharge means 103 are integrated or arranged at positions close to each other. After the plasma irradiating, the plasma irradiating means 102 and the drop discharge means 103, which are integrated, are quickly moved to a processing position by moving means 105. Since the landing position has affinity for liquid as it was irradiated with plasma, and the non-landing region 100 is liquid-repellent, an discharged composition 107 that landed by moving the drop discharge means 103 has no problem of moving after the landing and the discharged composition can be accurately formed. It is also possible to discharge a drop at the plasma-irradiate position without moving the drop discharge means 103 after the plasma irradiating by the plasma irradiating means 102. In this case, however, it is necessary to incline the piezoelectric element and discharge port of the drop discharge means 103 or change electric signals.

As a power source for plasma generation, a high-frequency power source or high-voltage pulse power source is used. It is preferred that a high-frequency is in a frequency of 10 to 100 MHz, the frequency of the pulse power source is 50 Hz to 100 kHz, and the pulse duration is 1 to 100 μsec. The pressure is atmospheric pressure or within a range close to atmospheric pressure, and the range of pressure may be 1.3×10¹ to 1.31×10⁵ Pa. In a reduced-pressure atmosphere rather than at atmospheric pressure, the probability of collision of gas molecules and floating matter between the discharge and landing of the drop is reduced and therefore the landing accuracy tends to improve. As a reactive gas used for plasma generation for providing affinity for liquid, one or plural gases of inert gases such as He, Ne, Ar, Kr and Xe, and oxygen and nitrogen may be properly selected and used.

As a drop discharge material, any material that can be discharged as a drop when dissolved in a solvent may be used. For example, a conductive material to be a wiring, a resist material, a resin material to be an orientation film, a light-emitting material used for a light-emitting element, an etching solution used for wet etching and the like may be used.

As for the plasma irradiating means 102 and the drop discharge means 103, which are integrated, plural units of these may be collectively used as a single processing mechanism. Alternatively, the plasma irradiating means 102 and the drop discharge means 103 can be separately used for different purposes, respectively. Also in the case of separately using them, plural units of each can be collectively used as a single processing mechanism. In this means, the plasma processing means 102 is constructed for the purpose of surface modification of the surface to be processed, but it can also be used as plasma processing means for film forming and etching, when necessary.

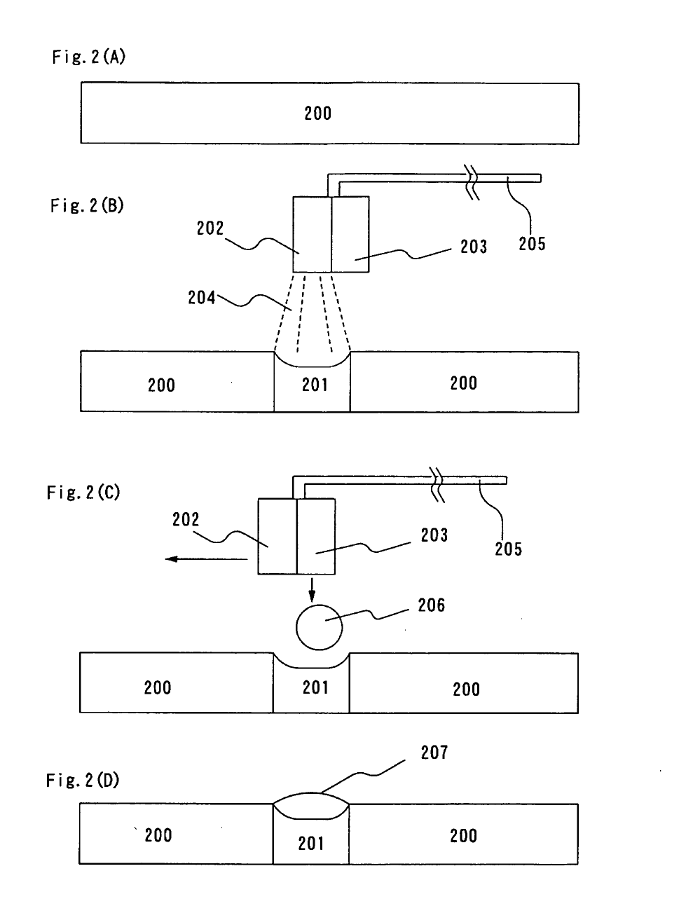

Next, an embodiment will be described with reference to FIG. 2, in which a drop is caused to land accurately on a surface having affinity for liquid and the position of an discharged composition after the landing is controlled. Plasma irradiating to a drop discharge-scheduled region 201 on the surface of the thin film 200 is performed by plasma irradiating means 202.

In the region 201 irradiated with plasma, a groove is formed in which a drop composition 206 to be discharged will be housed, by hydrogen as a reducing gas or an etching gas CF₄, CHF₃, SF₆ or the like. The size of the groove is adjusted by the quantity of the drop to be discharged and the groove with a suitable size for housing the drop is formed. Instead of etching the plasma-irradiate region 201 to form the above-described groove, the surface asperity may be changed to improve the contact property with a discharged composition. In the groove formed by the above-described plasma irradiating, the drop composition 206 is discharged by drop discharge means 203, thus forming a pattern. The plasma irradiating means 202 and the drop discharge means 203 are integrated or arranged at positions close to each other. The plasma irradiating means 202 and the drop discharge means 203, which are integrated, are moved to a processing position by moving means 205. Since the plasma-irradiate position and the drop discharge position are not the same, the drop discharge means 203 is quickly moved after the plasma irradiating and discharges the drop composition. Since the groove is formed at the landing position, a discharged composition 207 that landed has no problem of moving to the non-landing region 200 after the landing. It is also possible to discharge a drop at the plasma-irradiate position without moving the drop discharge means 203 after the plasma irradiating by the plasma irradiating means 202. In this case, however, it is necessary to incline the piezoelectric element and discharge port of the drop discharge means 203 or change electric signals.

As a power source for plasma generation, a high-frequency power source or high-voltage pulse power source is used. It is preferred that a high-frequency is in a frequency of 10 to 100 MHz, the frequency of the pulse power source is 50 Hz to 100 kHz, and the pulse duration is 1 to 100 μsec. The pressure is atmospheric pressure or within a range close to atmospheric pressure, and the range of pressure may be 1.3×10¹ to 1.31×10⁵ Pa. In a reduced-pressure atmosphere rather than at atmospheric pressure, the probability of collision of gas molecules and floating matter between the discharge and landing of the drop is reduced and therefore the landing accuracy tends to improve.

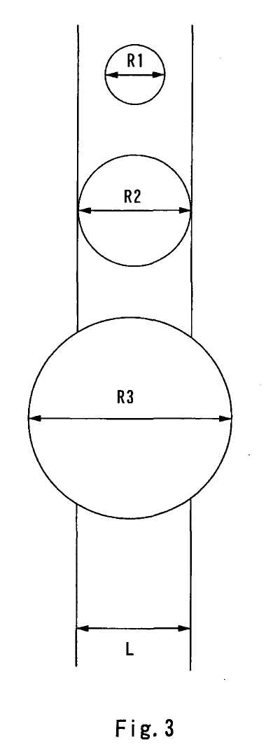

FIG. 3 shows the relation between a plasma-irradiate region L and the drop diameter at the time of landing. When R1<L, R2=L and R3>L hold, in order to maintain the discharged composition at a position where the diameter R at the time of landing is constantly stable, it is important to satisfy the relation of R/2<L≦R irrespective of the affinity for liquid or formation of a groove in the plasma-irradiate region L.

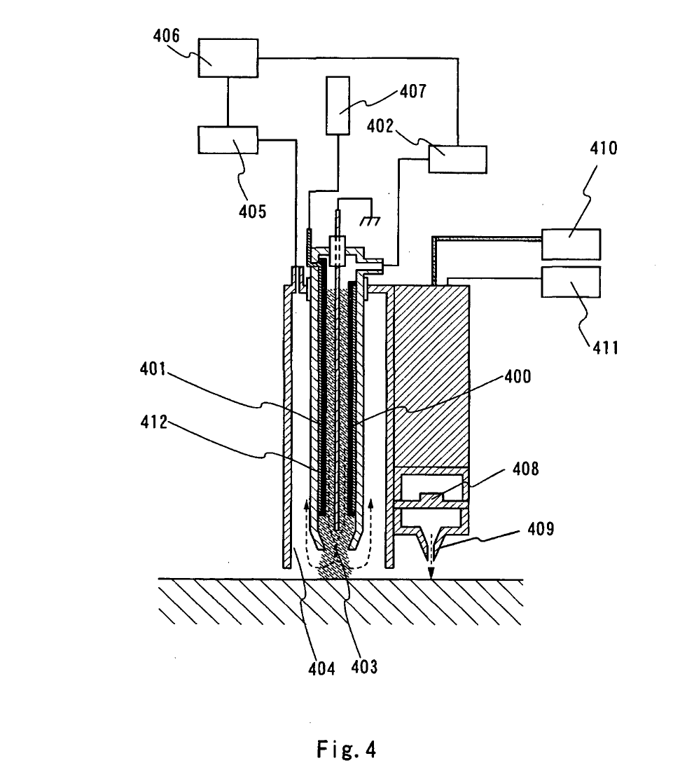

FIG. 4 shows a structure in which a nozzle unit suitable 1 for the case of performing surface modification and etching with plasma gas or reactive radicals or ion species and a nozzle unit for drop discharge are integrated. The nozzle unit for plasma processing will now be described. The nozzle unit is provided with gas supply means 402 for supplying gas for performing surface treatment and its exhaust means 405, and the gas supplied from the gas supply means 402 is made plasma or reactive radicals or ion species are generated from the gas in an inner gas supply tube 400 and the resulting gas or radicals/ion species are sprayed to a processing target from a gas discharge port 403. After that, the gas is exhausted from an outer gas exhaust tube 404 by the exhaust means 405.

Also, gas refining means 406 may be provided between the gas supply means 402 and the gas exhaust means 405 and incorporated in the structure for circulating the gas. By incorporating such a structure, the consumption of the gas can be reduced. The gas exhausted from the exhaust means 405 may be recovered, refined and used again by the gas supply means 402.

To maintain stable discharge at atmospheric pressure or a pressure close to atmospheric pressure, the spacing between the nozzle unit and the processing target is preferably 50 mm or less, and more preferably 10 mm or less.

The most desirable shape of this nozzle is a coaxial cylindrical shape about electrodes 401 provided on the inner side of the inner gas supply tube 400 and solid dielectric materials 412 installed on the electrodes 401. However, the configuration of the shape of the nozzle is not limited to this shape as long as the nozzle can similarly supply plasma gas locally. The spacing between the electrodes is determined in consideration of the thickness of the solid dielectric materials, the magnitude of applied voltage, the purpose of using plasma and the like, but it is preferably 1 to 7 mm. An irradiating port for plasma irradiating is narrower than the spacing between the electrodes.

The electrodes 401 may be formed in a stick-like, spherical, flat, thecal or like shape, using stainless steel, brass or other alloys, or aluminum, nickel or other simple metals. The solid dielectric materials 412 installed on the electrodes 401 must completely cover the electrodes 401. If there are portions not covered by the solid dielectric materials and where the electrodes directly face each other, arc discharge occurs therefrom. The solid dielectric materials may be metal oxides such as silicon dioxide, aluminum oxide, zirconium dioxide and titanium dioxide, plastics such as polyethylene terephthalate and polytetrafluoroethylene, glass, composite oxides such as barium titanate and the like. The shape of the solid dielectric materials may be sheet-like or film-like, however it is preferred that it has a thickness of 0.05 to 4 mm. Since a high voltage is required for generating discharge plasma, if the solid dielectric materials are too thin, dielectric breakdown occurs at time of voltage application and arc discharge occurs. As a power source 407 for supplying power to the electrodes 401, a direct current (DC) power source or high-frequency power source can be applied. In the case of using a DC power source, it is preferred to supply power intermittently in order to stabilize discharge, and it is preferred that the power source has a frequency of 50 Hz to 100 kHz and a pulse duration of 1 to 100 μsec.

In the selection of the processing gas, for the purpose of performing processing to selectively form a region having affinity for liquid on the liquid-repellent surface, one or plural gases of inert gases such He, Ne, Ar, Kr and Xe, and oxygen and nitrogen is used. On the other hand, for the purpose of etching the surface having affinity for liquid and thus forming a groove thereon, a suitable combination of a reducing gas such as hydrogen, carbon tetrafluoride (CF₄), nitrogen trifluoride (NF₃), sulfur hexafluoride (SF₆), other fluoride gases, and oxygen (O₂) may be used. To maintain stable discharge, these fluoride gases may be diluted with noble gas such as helium, argon, krypton, or xenon.

The atmospheric pressure or pressure close to the atmospheric pressure may be set at 1.30×10¹ to 1.31×10⁵ Pa. In this case, to maintain the reaction space at a reduced pressure lower than the atmospheric pressure, the nozzle unit and the processing target substrate may be held in a reaction chamber that forms a closed space, and a reduced-pressure state in the reaction chamber may be maintained by the exhaust means.

Next, the nozzle unit for drop discharge will be described. An electric signal 411 is sent to a piezoelectric element 408, and an discharge composition is fed from a drop cartridge 410 at the timing of the electric signal 411 and discharged from an discharge port 409 to the region where plasma processing was performed. At this point, at a pressure lower than the atmospheric pressure, the probability of collision of gas molecules and floating matter between the discharge and landing is reduced and therefore the landing accuracy tends to improve. Moreover, as the drop is discharged into the region changed to have affinity for liquid by plasma processing or into the groove part, a pattern having no drop shift after the landing is formed. Since the drop discharge means is not in contact with the processing substrate, it is advantageously in saving of space, material use efficiency, multiple applicability, drop landing accuracy, and formation of fine-dimension pattern in comparison to a screen printing method.

While the nozzle unit for performing plasma processing and the nozzle unit for performing drop discharge are integrated in FIG. 4, these nozzle units may be away from each other at a proper distance. The plasma processing means is not limited to the purpose of surface modification and may be used separately from the drop discharge means for the purpose of film forming and etching.

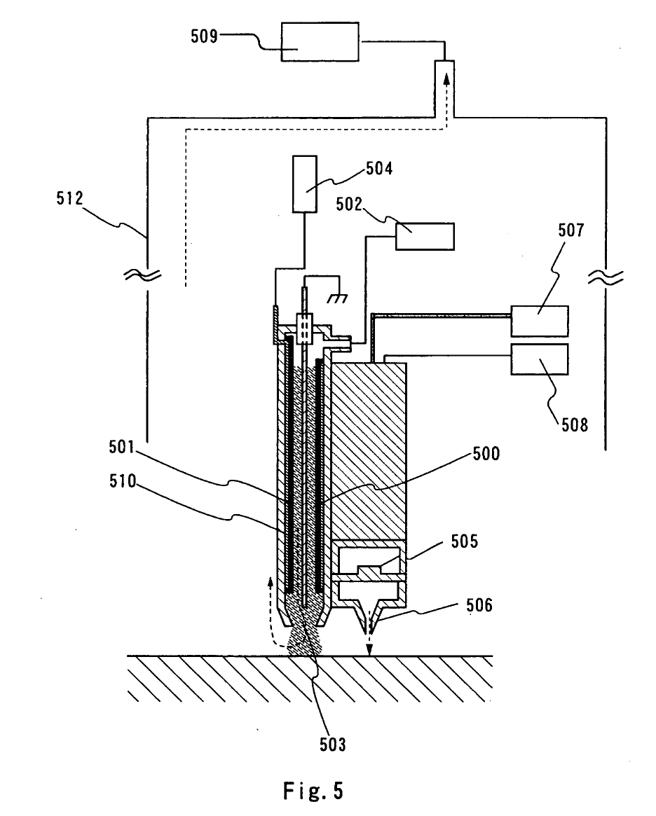

FIG. 5 shows a nozzle mechanism in which a plasma processing nozzle handles only harmless gas, and it has a simpler structure than in FIG. 4. A nozzle unit is provided with gas supply means 502 for supplying gas for performing surface treatment and its exhaust means 509, and the gas supplied from the gas supply means 502 is made plasma or reactive radicals or ion species are generated from the gas in an inner gas supply tube 500 and the resulting gas or radicals/ion species are sprayed to a processing target from a gas discharge port 503. After that, the gas is exhausted by the collective exhaust means 509 since a hood 512 surrounding the apparatus is installed on the outer side of the apparatus.

To maintain stable discharge at atmospheric pressure or a pressure close to atmospheric pressure, the spacing between the nozzle unit and the processing target is preferably 50 mm or less, and more preferably 10 mm or less.

The most desirable shape of this nozzle is a coaxial cylindrical shape about electrodes 501 provided on the inner side of the inner gas supply tube 500 and solid dielectric materials 510 installed on the electrodes 501. However, the configuration of the shape of the nozzle is not limited to this shape as long as the nozzle can similarly supply plasma gas locally. The spacing between the electrodes is determined in consideration of the thickness of the solid dielectric materials, the magnitude of applied voltage, the purpose of using plasma and the like, but it is preferably 1 to 7 mm. An irradiating port for plasma irradiating is narrower than the spacing between the electrodes.

The electrodes 501 may be formed in a stick-like, spherical, flat, thecal or like shape, using stainless steel, brass or other alloys, or aluminum, nickel or other simple metals. The solid dielectric materials 510 installed on the electrodes 501 must completely cover the electrodes 501. If there are portions not covered by the solid dielectric materials and where the electrodes directly face each other, arc discharge occurs therefrom. The solid dielectric materials may be metal oxides such as silicon dioxide, aluminum oxide, zirconium dioxide and titanium dioxide, plastics such as polyethylene terephthalate and polytetrafluoroethylene, glass, composite oxides such as barium titanate and the like. The shape of the solid dielectric materials may be sheet-like or film-like, but it is preferred that it has a thickness of 0.05 to 4 mm. Since a high voltage is required for generating discharge plasma, if the solid dielectric materials are too thin, dielectric breakdown occurs at time of voltage application and arc discharge occurs. As a power source 504 for supplying power to the electrodes 501, a DC power source or high-frequency power source can be applied. In the case of using a DC power source, it is preferred to supply power intermittently in order to stabilize discharge, and it is preferred that the power source has a frequency of 50 Hz to 100 kHz and a pulse duration of 1 to 100 μsec.

The selection of the processing gas is made only for the purpose of performing processing to selectively form a region having affinity for liquid on the liquid-repellent surface. As the processing gas, one of inert gases such as He, Ne, Ar, Kr and Xe, and oxygen and nitrogen is used.

The atmospheric pressure or pressure close to the atmospheric pressure may be set at 1.30×10¹ to 1.3×10⁵ Pa. In this case, to maintain the reaction space at a reduced pressure lower than the atmospheric pressure, the nozzle unit and the processing target substrate may be held in a reaction chamber that forms a closed space, and a reduced-pressure state in the reaction chamber may be maintained by the exhaust means.

Next, the nozzle unit for drop discharge will be described. An electric signal 508 is sent to a piezoelectric element 505, and a discharge composition is fed from a drop cartridge 507 at the timing of the electric signal and discharged from a discharge port 506 to the region where plasma processing was performed. At this point, at a pressure lower than the atmospheric pressure, the probability of collision of gas molecules and floating matter between the discharge and landing is reduced and therefore the landing accuracy tends to improve. Moreover, as the drop is discharged into the region changed to have affinity for liquid by plasma processing or into the groove part, a pattern having no drop shift after the landing is formed.

While the nozzle unit for performing plasma processing and the nozzle unit for performing drop discharge are integrated in FIG. 5, these nozzle units may be away from each other at a proper distance.

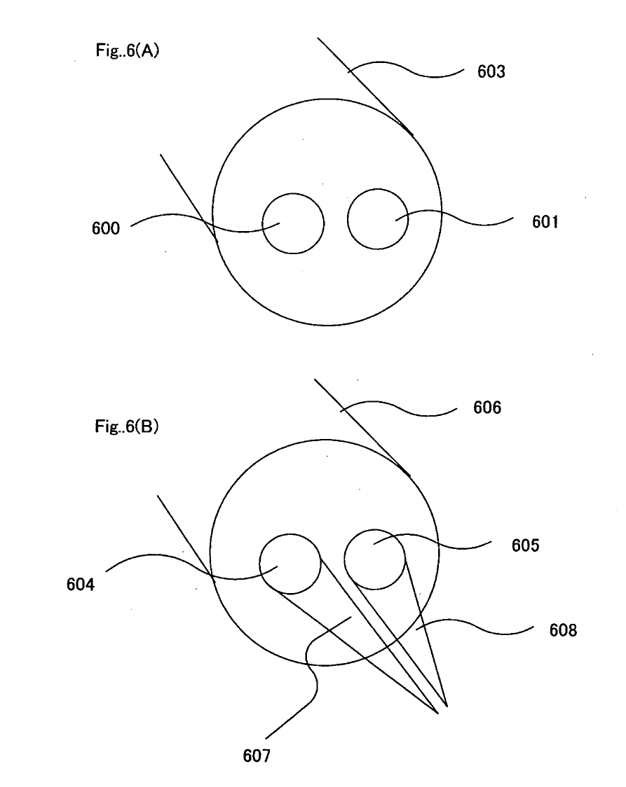

FIG. 6 shows schematic structures in which plasma processing means and drop discharge means are integrated. FIG. 6 shows a surface of plasma process and drop discharge process. FIG. 6(A) shows a structure in which an integrated cylindrical nozzle 603 has a plasma processing port 600 and a drop discharge port 601 arrayed as close to each other as possible. The quantities of plasma and drop discharged from their respective processing ports can be properly determined in accordance with the size of a processing target pattern. However, in the plasma processing, the quantity of plasma is also changed by the gas flow rate and pressure, and also in the drop discharge, the quantity of drop is changed by the magnitude and switching mode of a pulse voltage to the piezoelectric element. The shape of the processing ports is not limited to a circular shape as shown in FIG. 6(A) and may be changed to an elliptic, rectangular, square, triangular or like shape in accordance with applications.

In FIG. 6(B), the heads of the processing ports shown in FIG. 6(A) are processed and changed for processing a finer and smaller region. In a cylindrical nozzle 606, a plasma processing port 604 is connected with a nozzle 607 having a tapered end. Also a drop discharge port 605 is connected with a nozzle 608 having a tapered end. The plasma processing nozzle 607 and the drop discharge nozzle 608 are arrayed as close to each other as possible. Thus, it is possible not only to process a fine region but also to discharge a drop at a plasma-processed position without moving after the plasma processing.

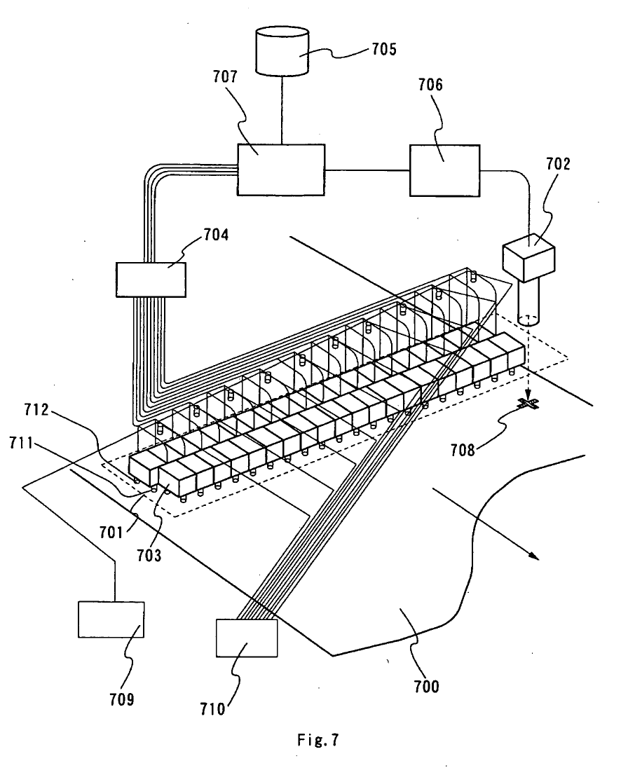

FIG. 7 illustrates a mode of pattern plotting means having a set of many nozzles in which plasma processing means and drop discharge means are integrated. Plasma processing means and drop discharge means 701 are provided on a substrate 700. In FIG. 7, the plasma processing means and drop discharge means 701 do not move on the substrate, but the substrate 700 is processed as plural rotary shafts under the substrate 700 rotate properly. These plasma processing means and drop discharge means 701 use plural heads, each of which has a plasma irradiating port 711 and a drop discharge port 712, and these heads are arrayed in a uniaxial direction (direction of the width of the substrate 700). Image pickup means 702 is provided for detecting a marker position on the substrate 700 and observing a pattern. It suffices that the head of the plasma irradiating port 711 controls the quantity and timing of plasma irradiating. It suffices that the head 712 of the drop discharge means can control the quantity of a composition to be discharged or dropped and its timing. It may have a structure for discharging the composition by using a piezoelectric element as in the ink jet method, or a structure for controlling the quantity of drop by providing a needle valve at the discharge port.

Dispensers 703 constituting the plasma processing means and drop discharge means 701 need not necessarily perform simultaneous discharge operation at the same timing, and a target pattern can be formed by controlling the timing of the plasma irradiating and the discharge of the composition by the individual heads 711, 712 in accordance with the movement of the substrate 700.

As the individual heads 712 of the drop discharge means are connected to control means and the control means is controlled by a computer 707, a pattern that has been programmed in advance can be plotted. The timing of plotting may be taken, for example, with reference to a marker 708 formed on the substrate 700. The marker is detected by the image pickup means 702 and converted to a digital signal by image processing means 706, and the computer 707 recognizes the digital signal and generates and sends a control signal to the control means 704. Of course, information of a pattern to be formed on the substrate 700 has been stored in a storage medium 705. On the basis of this information, a control signal is sent to the control means 704 so that the individual heads 712 of the drop discharge means can be separately controlled.

Also the individual heads 711 of the plasma irradiating means are connected to the control means, as in the drop discharge means, and as the control means is controlled by the computer 707, plasma irradiating to a pattern that has been programmed in advance can be performed. The plasma irradiating heads 711 are connected to gas supply means 709 and a power source 710 for their electrodes. No gas exhaust means is installed in each dispenser 703 and gas is collectively drained by a hood covering the apparatus, though not particularly shown in FIG. 7.

Embodiments

[Embodiment 1]

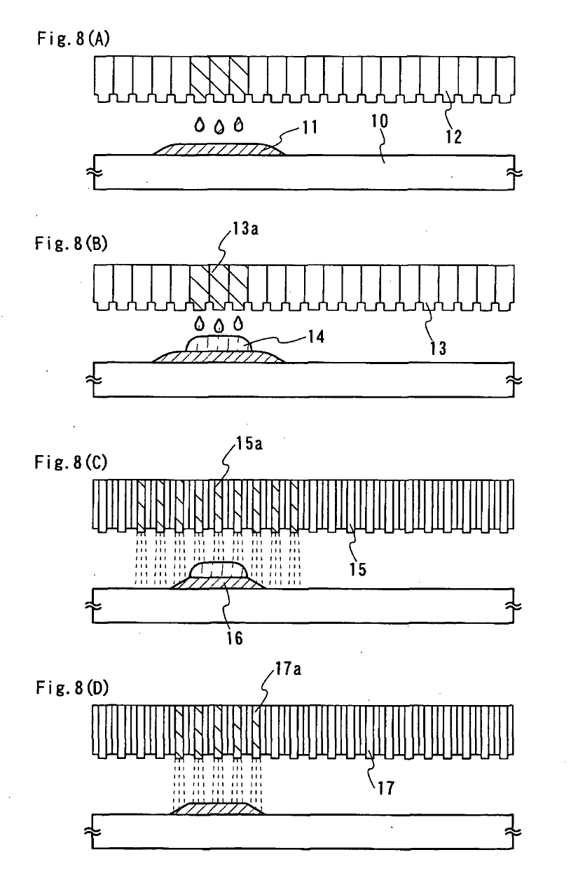

An embodiment of this invention will be described with reference to FIGS. 8 to 11.

FIG. 8(A) shows a step of forming a conductive coating for forming a gate electrode and a wiring.

An optically transparent substrate of glass, quartz or the like is used, but the substrate to be used is not limited to an optically transparent and any other substrate may be used as long as it is durable against the processing temperature at each step. As for the size of a substrate 1500, it is preferred to use a large-area substrate having a size of 600 mm by 720 mm, 680 mm by 880 mm, 1000 mm by 1200 mm, 1100 mm by 1250 mm, 1150 mm by 1300 mm, 1500 mm by 1800 mm, 1800 mm by 2000 mm, 2000 mm by 2100 mm, 2200 mm by 2600 mm, or 2600 mm by 3100 mm, so as to reduce the manufacturing cost. On the substrate 10, a conductive film 11 of aluminum, titanium, tantalum, molybdenum or the like is formed by film forming means having a nozzle unit in which plural discharge ports are arrayed in a uniaxial direction. The conductive material to be discharged may be a conductive composition containing fine metal particles with a particular diameter of approximately 1 μm, or a conductive high-molecule composition in which fine metal particles with a particle diameter of approximately 1 μm and ultra-fine particles of nano-micro size have been dispersed. Since the conductive film 11 is discharged in the form of solvent-based paste, it has poor contact property to the glass substrate. Therefore, before the discharge, a fine groove for housing discharged liquid is formed in the discharge region on the surface of the glass substrate by plasma processing as described in the embodiment, using a proper combination of a reducing gas such as hydrogen, carbon tetrafluoride (CF₄), nitrogen trifluoride (NF₃), sulfur hexafluoride (SF₆), other fluoride gases, and oxygen (O₂) or the like. Instead of forming a groove, processing to increase asperity on the surface may be performed to improve the contact property to the substrate. Moreover, to maintain stable discharge, these fluoride gases may be diluted with noble gas such as helium, argon, krypton or xenon. As a power source for plasma generation, a high-frequency power source or high-voltage pulse power source is used. It is preferred that a high-frequency is in a frequency of 10 to 100 MHz, the frequency of the pulse power source is 50 Hz to 100 kHz, and the pulse duration is 1 to 100 μsec. The pressure is atmospheric pressure or within a range close to atmospheric pressure, and the range of pressure may be 1.3×10¹ to 1.31×10⁵ Pa. When discharging a drop, in a reduced-pressure atmosphere rather than at atmospheric pressure, the probability of collision of gas molecules and floating matter between the discharge and landing of the drop is reduced and therefore the landing accuracy tends to improve. As a reactive gas used for plasma generation for providing affinity for liquid, one or plural gases of inert gases such as He, Ne, Ar, Kr and Xe, and oxygen and nitrogen may be properly selected and used. The conductive film 11 need not be formed on the entire surface of the substrate 10 and may be selectively formed around the region where a gate electrode or wiring is to be formed. After the conductive metal drop is discharged onto the substrate, the drop is dried at 100° C. for three minutes and then baked at 200 to 500° C. for 15 to 30 minutes. Before the drying, the conductive film may be rubbed and flattened by a roller or the like.

After that, in order to improve the contact property, plasma of oxygen, nitrogen, helium or the like is irradiated by drop discharge means 13 having plural plasma irradiating ports and composition discharge ports arrayed in a uniaxial direction, and then a resist composition is selectively discharged to form a mask pattern 14 for forming a gate electrode on the conductive film 11, as shown in FIG. 8(B). In this case, since the drop discharge means has the discharge ports arrayed only in a uniaxial direction, it suffices to operate heads only at required positions (13a). To process the entire surface of the substrate, one or both of the substrate 10 and the plasma processing means and drop discharge means 13 may be moved. Such processing is similarly performed in the following steps.

FIG. 8(C) shows a step of etching using the mask pattern 14 to form a gate electrode and wiring 16. The etching is performed by using film removal means in which plural plasma discharge ports are arrayed in a uniaxial direction. For etching the conductive film 11, fluoride gas or chloride gas is used. Nozzle units 15 need not discharge this reactive gas onto the entire surface of the substrate 10, and it suffices to operate nozzle units 15a of the nozzle units 15, facing the region where the conductive film 11 is formed, to process only that region.

FIG. 8(D) shows a step of removing the mask pattern 14. Film removal means having plural plasma discharge ports arrayed in a uniaxial direction is used. Nozzle units 17 perform oxygen plasma processing for ashing, but again they need not perform this processing on the entire surface of the substrate and it suffices to operate only nozzle units 17a around the region where the mask pattern is formed and thus selective perform the processing.

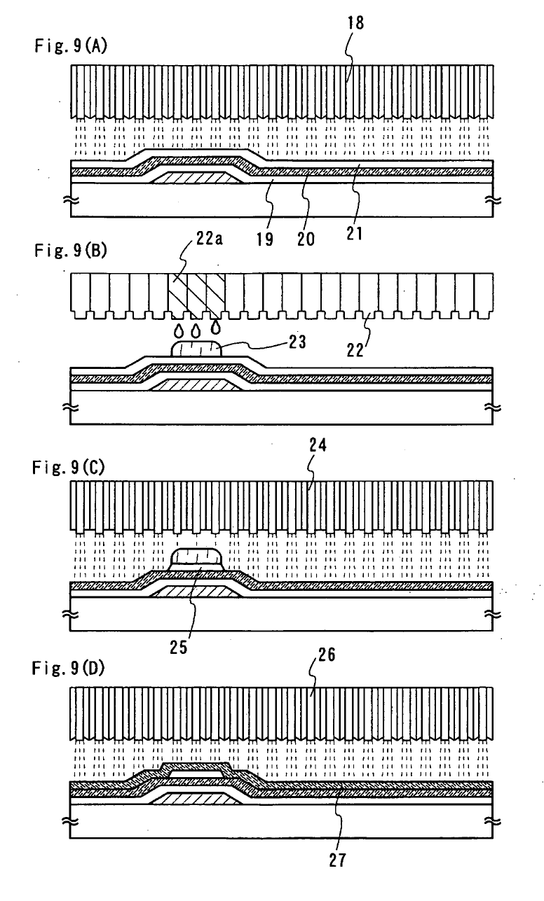

In FIG. 9(A), a gate insulating film 19, a non-single crystal silicon film 20 and a passivation film 21 are formed. For forming a multilayer body of these films, plural nozzle units 18 responsible for forming the individual films, respectively, may be prepared to continuously form the films, or the films may be sequentially stacked by switching the reactive gas species every time the nozzle units 18 perform scanning once. Since the region where the films should be formed is not the entire surface of the substrate 10, the films may be formed by supplying plasma reactive gas from the entire surfaces of the nozzle units 18, for example, only into a region where a TFT should be formed. In the case of forming a silicon oxide film, it is also possible to make a choice of using oxide gas of silane and oxygen or the like, or using TEOS. The gate insulating film 19 may be formed on the entire surface of the substrate, or of course, it may be selectively formed around the region where a TFT is to be formed.

FIG. 9(B) shows a step of forming a mask pattern 23. After plasma of oxygen, nitrogen, helium or the like is irradiated to improve the contact property by plasma processing means and drop discharge means 22 having plural composition discharge ports arrayed in a uniaxial direction, a resist composition is selectively discharged to form the mask pattern 23 for forming a passivation film for a channel portion.

FIG. 9(C) shows a step of etching the passivation film 21 by using the mask pattern 23 and thus forming a passivation film 25 for the channel portion. The channel passivation film made of a silicon nitride film may be formed by using fluoride gas such as SF₆.

After that, the mask pattern 23 is removed by film removal means, as in the case of FIG. 9(D).

FIG. 9(D) shows a step of forming a non-single crystal silicon film 27 of one conductivity type for forming source and drain of a TFT. Typically, an n-type non-single crystal silicon film is formed, and reactive gas supplied from nozzle units 26 may be a mixture of silicide gas such as silane and gas containing an element of the 15^{th} group in the periodic table such as phosphine.

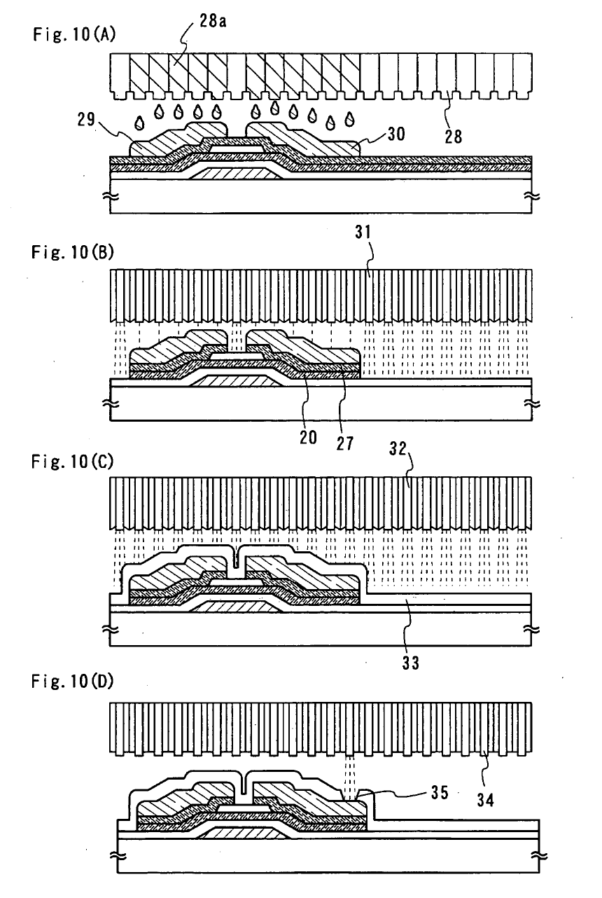

FIG. 10(A) shows a step of improving the contact property by plasma processing and then applying solvent-based conductive paste in order to form source and drain wirings. Plasma processing means and drop discharge means 28 may have a structure for irradiating plasma of oxygen, nitrogen, helium or the like to improve the contact property and then discharging a drop by using a piezoelectric element, or it may employ a dispenser system. In any case, a conductive composition containing fine metal particles with a particle diameter of approximately 1 μm is selectively dropped to directly form wiring patterns of source 29 and drain 30. Alternatively, a conductive high-molecule composition in which fine metal particles with a particle diameter of approximately 1 μm and ultra-fine particles of nano-micro size have been dispersed may be used. Using this, a significant effect is achieved that contact resistance with the non-single crystal silicon film 27 of one conductivity type can be reduced. After that, to volatilize the solvent of the composition and thus harden the wiring patterns, heated inert gas may be similarly sprayed from the nozzle units or the composition may be heated by a halogen lamp heater, oven, or furnace, as heating means. The baking temperature is 100° C. and drying is performed for three minutes. Then, baking is performed at 200 to 500° C. for 15 to 30 minutes. Before the drying, the conductive film may be rubbed and flattened by a roller or the like so that unevenness on the surface of the conductive film is eliminated.

In FIG. 10(B), using the source wiring 29 and the drain wiring 30 as masks, the non-single crystal silicon film 27 of one conductivity type and the non-single crystal semiconductor film 20 situated below the wirings are etched. In the etching, plasma fluoride gas is irradiated from nozzle units 31. In the etching, plasma fluoride gas is irradiated from nozzle units 31. Also in this case, the quantity of the reactive gas to be sprayed is varied between the vicinity of the wiring forming region and the other region. As a large quantity of the reactive gas is discharged into the region where the non-single crystal silicon film is exposed, the etching is balanced and the consumption of the reactive gas can be saved.

FIG. 10(C) shows a step of forming a passivation film on the entire surface. Plasma reactive gas is discharged from nozzle units 32, and typically, a silicon nitride film 33 is formed. Since the conductive film contains ultra-fine particles with a particle diameter of approximately 1 μm, thermal diffusion of the ultra-fine particles into the thin film in contact with the conductive film may be feared. However, the silicon nitride film has better diffusion prevention and passivation capability than the oxide film. Moreover, the silicon nitride film may be doped with Ar or the like to cause the silicon nitride film to be a harder barrier film.

FIG. 10(D) shows formation of a contact hole. As plasma reactive gas is selectively discharged at a place where a contact hole is to be formed by using nozzle units 34, a contact hole 35 can be formed without using a mask. Alternatively, wet etching may be performed locally by using a HF-based wet etching solution instead of the plasma gas. In this case, after dropping the etching solution, pure water is dropped to eliminate the etching solution so that etching does not proceed too much.

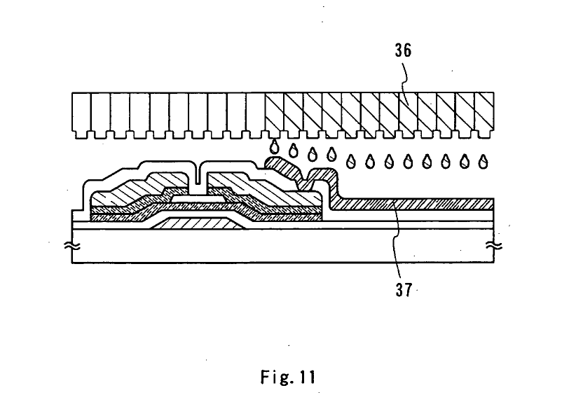

After that, a transparent electrode 37 is formed, as shown in FIG. 11. Plasma processing means and drop discharge means 36 irradiates plasma of oxygen, nitrogen, helium or the like into the drop discharge region to improve the contact property, and then discharges a drop to be a transparent electrode. Also in this case, a structure for discharging the drop by using a piezoelectric element may be used, or a dispenser system may be used. As the transparent electrode material to be discharged, a conductive composition containing fine metal particles with a particle diameter of approximately 1 μm, or a conductive high-molecule composition in which fine metal particles with a particle diameter of approximately 1 μm and a ultra-fine particles of nano-micro size have been dispersed, may be used. As a composition containing power made of conductive particles of indium tin oxide, tin oxide, zinc oxide or the like is formed by the drop discharge means, particularly the resistance between the non-single crystal silicon film 27 of one conductivity type and the contact part can be lowered. At this step, a pixel electrode is formed. After discharging the transparent electrode material, to volatilize the solvent of the composition and thus harden the wiring patterns, heated inert gas may be similarly sprayed from the nozzle units or the composition may be heated by a halogen lamp heater, oven, or furnace, as heating means. The baking temperature is 100° C. and drying is performed for three minutes. Then, baking is performed at 200 to 500° C. for 15 to 30 minutes. Before the drying, the conductive film may be rubbed and flattened by a roller or the like so that unevenness on the surface of the transparent electrode is eliminated.

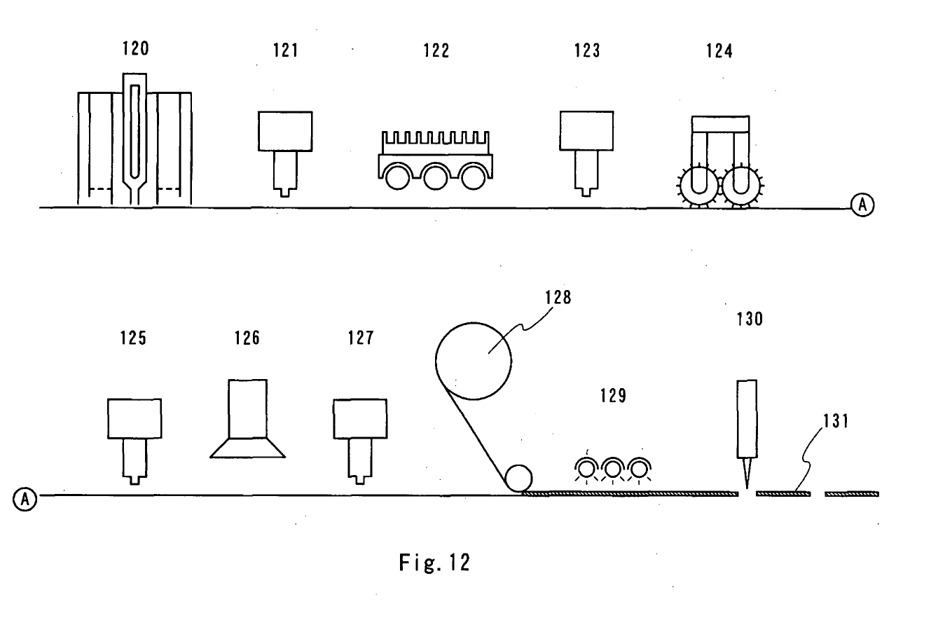

The subsequent step is a step required in the case of manufacturing a liquid crystal display device, and non-contact drop discharge means is used also at the following step. As shown in FIG. 12, an orientation film is formed by plasma processing means 120, drop discharge means 121 and heating means 122, and rubbing processing is performed by rubbing means 124. Moreover, after a sealant is plotted by drop discharge means 125 and spacers are splayed by spraying means 126, liquid crystal is dropped on the substrate by liquid crystal dropping means 127.

On the counter-side, a substrate is supplied from another reel-out roller 128 and the two substrates are bonded together. As the sealant is hardened by hardening means 129, the two substrates are fixedly adhered to each other. Moreover, the adhered substrates are cut out in a proper panel size by scribing means 130 and a liquid crystal panel 131 can be thus manufactured.

In the above-described manner, a display device is produced by using the method for manufacturing a semiconductor device according to this invention.

[Embodiment 2]

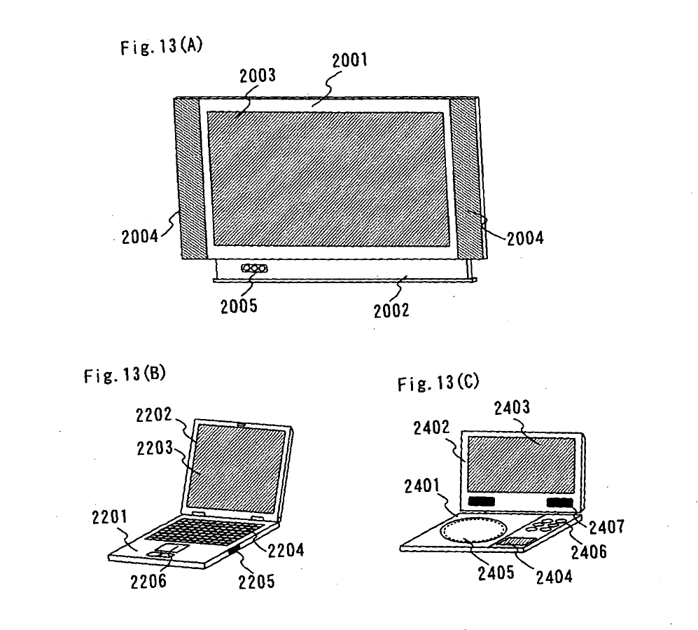

Using the display device formed by carrying out this invention, a television receiver, a computer and a video reproducing apparatus illustrated in FIG. 13 and other electronic devices can be completed.

FIG. 13(A) shows an example of completing a television receiver by applying this invention. The television receiver is constituted by a casing 2001, a supporting stand 2002, a display unit 2003, speaker units 2004, a video input terminal 2005 and the like. By utilizing this invention, particularly a television receiver with a screen size of 30 inches or more can be manufactured at a low cost. Moreover, by utilizing this invention, the television receiver can be completed.

FIG. 13(B) shows an example of completing a notebook model personal computer by applying this invention. The personal computer is constituted by a body 2201, a casing 2202, a display unit 2203, a keyboard 2204, an outer connection port 2205, a pointing mouse 2206 and the like. By utilizing this invention, a personal computer having the display unit 2203 of 15 to 17-inch class can be manufactured at a low cost.

FIG. 13(C) shows an example of a video apparatus by applying this invention. The video apparatus is constituted by a body 2401, a casing 2402, a display unit A 2403, a display unit B 2404, a recording medium reading unit 2405, operating keys 2406, speaker units 2407 and the like. By utilizing this invention, a video reproducing apparatus having light weight as well as the display unit 2203 of 15 to 17-inch class can be manufactured at a low cost.

[Embodiment 3]

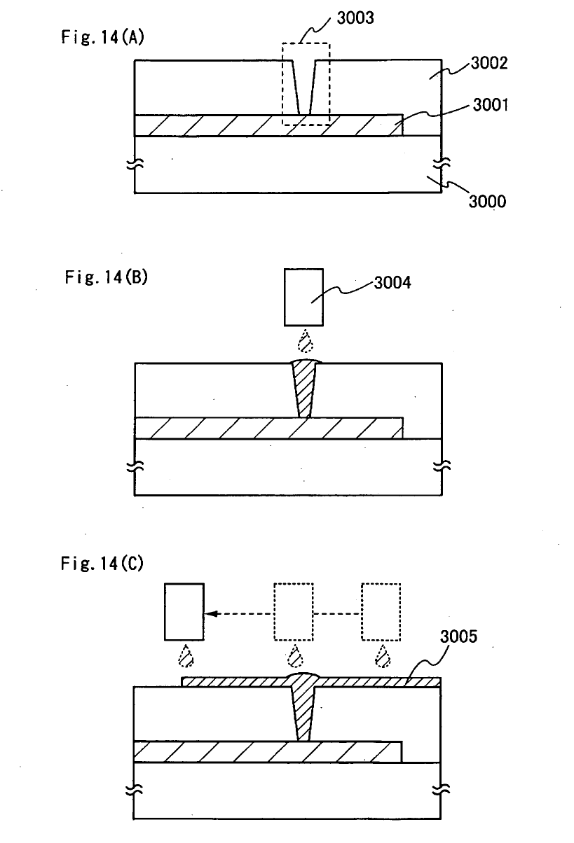

In this embodiment, a method of filling a contact hole (opening) with a drop composition by using the drop discharge method will be described with reference to FIGS. 14 to 16.

In FIG. 14(A), a semiconductor 3001 is provided on a substrate 3000, and an insulator 3002 is provided on the semiconductor 3001. The insulator 3002 has a contact hole 3003. As a method for forming the contact hole, a known method may be used, alternatively the drop discharge method may also be used. In this case, a wet etching solution is discharged from a nozzle, thereby forming the contact hole 3003. In this way, formation of a contact hole and formation of a wiring can be continuously carried out by the drop discharge method.

Then, a nozzle 3004 is moved to a position above the contact hole 3003 and continuously discharges a drop composition into the contact hole 3003 to fill the contact hole 3003 with the drop composition (FIG. 14(B)). After that, as the position of the nozzle 3004 is reset and the nozzle selectively discharges the drop composition, a conductor 3005 with the drop composition filling the contact hole 3003 can be formed (FIG. 14(C)). In this method, the nozzle 3004 scans the same part plural times.

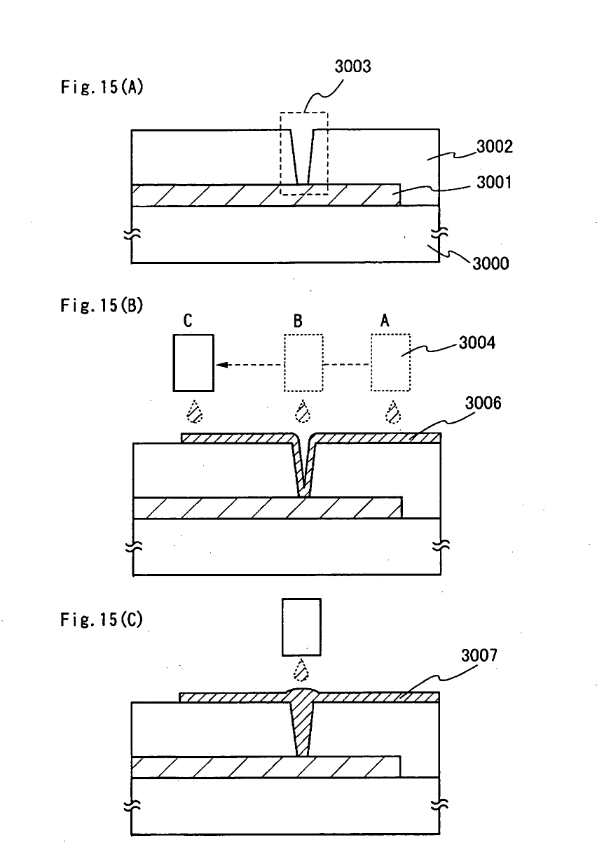

Next, a method that is different from the above-described method will be described with reference to FIG. 15. In this method, the nozzle 3004 is moved and selectively discharges a drop composition only in a region where a wiring is to be formed, thus forming a conductor 3006 (FIG. 15(B)). Next, the nozzle is moved to a position above the contact hole 3003 and continuously discharges the drop composition into the contact hole 3003. As a result, a conductor 3007 with the drop composition filling the contact hole 3003 can be formed (FIG. 15(C)). In this method, the nozzle 3004 scans the same part plural times.

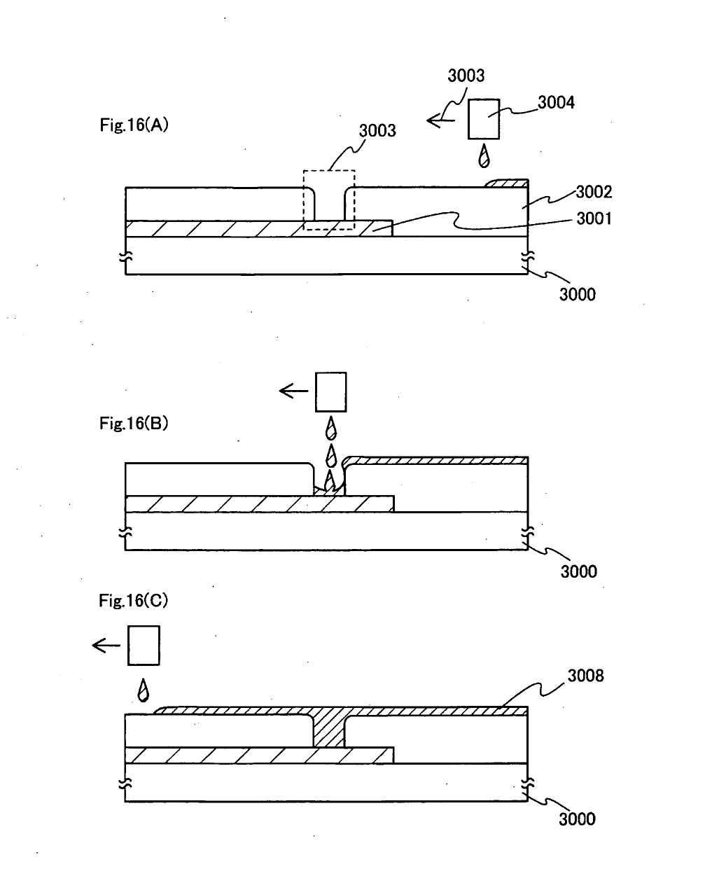

Next, a method that is different from the above-described methods will be described with reference to FIG. 16. In this method, first, the nozzle 3004 is moved and selectively discharges a drop composition (FIG. 16(A)). Then, when the nozzle 3004 has reached a position above the contact hole 3003, the nozzle continuously discharges the drop composition to fill the contact hole with the drop composition (FIG. 16(B)). As a result, a conductor 3008 with the drop composition filling the contact hole 3003 can be formed (FIG. 16(C)). In this method, the nozzle 3004 does not scan the same part plural times.

Using one of the above-described methods, a conductor with a drop composition filling a contact hole, too, can be formed.

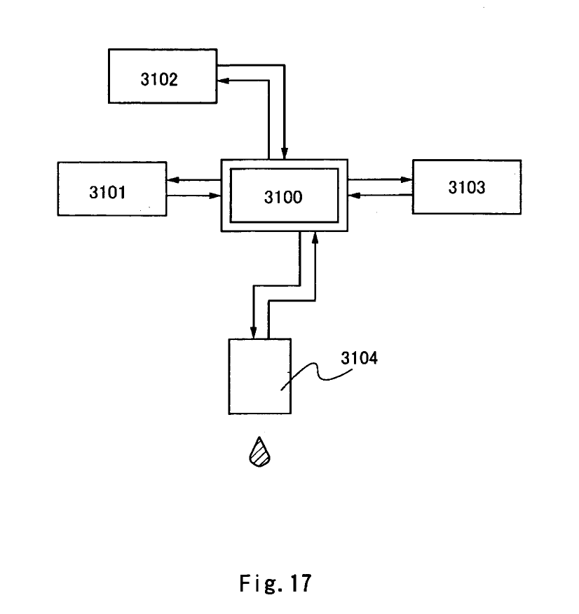

By using the drop discharge method, a circuit wiring inputted to a personal computer or the like can be produced immediately. A system used in this case will be briefly described with reference to FIG. 17.

A drop discharge apparatus having a CPU 3100, a volatile memory 3101, a non-volatile memory 3102, input means 3103 such as keyboard and operating buttons, and drop discharge means 3104, as backbone constituent elements, may be considered. The operation of the apparatus will be briefly described. When data of a circuit wiring is inputted by the input means 3103, this data is stored into the volatile memory 3101 or the non-volatile memory 3102 via the CPU 3100. Then, as the drop discharge means 3104 selectively discharges a drop composition on the basis of this data, a wiring can be formed.

With the above-described structure, a mask for the purpose of exposure is no longer necessary and steps of exposure, development and the like can be significantly reduced. As a result, the throughput increases and the productivity can be significantly improved. Moreover, this structure may also be used for the purpose of repairing disconnected parts of wirings and defective parts of electric connection between a wiring and an electrode. In this case, it is preferred to input a repair part into, for example, a personal computer, and cause a nozzle to discharge a drop composition at that part. Also, wirings can be easily formed on a large substrate of meter-size and it suffices to apply only a necessary quantity of material to a desired position. Therefore, since only a little quantity of material is wasted, improvement in material use efficiency and reduction in production cost are realized.

1. A pattern forming method comprising:
forming a liquid-repellent thin film on an insulating surface;
selectively providing affinity for liquid with a surface of the thin film by plasma generating means; and
forming a pattern by discharging a drop composition to the surface having affinity of liquid of the thin film by drop discharging means.

2. A pattern forming method comprising:
forming a thin film having affinity for liquid on an insulating surface;
selectively forming a groove or a hole in a surface of the thin film by plasma generating means; and
forming a pattern by discharging a drop composition to the groove or the hole in the thin film by drop discharging means.

3. A pattern forming method according to claim 1, wherein the drop composition is selected from the group consisting of a conductive material, a resist material, a polymer material and a light emitting material.

4. A pattern forming method according to claim 1, wherein the liquid-repellent thin film is selected from the group consisting of a semiconductor film, a conductive film and a polymer film.

5. A pattern forming method according to claim 2, wherein the thin film having affinity for liquid is selected from the group consisting of a silicon oxide film, silicon nitride film, a silicon oxynitride film and a metal oxide film.

6. A pattern forming method according to claim 1, wherein a pressure each of the plasma generating means and the drop discharging means is in a range of 1.3×10¹ to 1.31×10⁵ Pa.

7. A pattern forming method according to claim 1 or claim 2, wherein a contact angle θ of the surface having affinity for liquid is 0°≦θ<10°, and a contact angle θ of the liquid-repellent surface is 110° 0<<180°.

8. A drop discharging apparatus comprising:
plasma generating means which makes a surface of a liquid-repellent thin film selectively have affinity for liquid by using a plasma generated by applying a high frequency or a pulsed voltage to a first electrode or a second electrode in a condition where a process gas is introduced between the first electrode and the second electrode; and
drop discharging means which forms a pattern by discharging a drop composition to the surface having affinity for liquid of the thin film.

9. A drop discharging apparatus comprising:
plasma generating means selectively forms a groove on a surface of a thin film having affinity for liquid by using a plasma generated by applying a high frequency or a pulsed voltage to a first electrode or a second electrode in a condition where a process gas is introduced between the first electrode and the second electrode; and
drop discharging means which forms a pattern by discharging a drop composition to the groove.

10. A drop discharging apparatus according to claim 8, which has a structure in which the plasma generating means and the drop discharging means are integrated, or a structure in which a continuous process is possible.

11. A drop discharging apparatus according to claim 8, wherein the plasma generating means comprises an electrode on which a pair of solid dielectric material is installed, and a high frequency or a pulse power source which is introducing a process gas between electrodes.

12. A drop discharging apparatus according to claim 8, wherein the liquid-repellent thin film is selected from the group consisting of a semiconductor film, a conductive film and a polymer film.

13. A drop discharging apparatus according to claim 9, wherein the thin film having affinity for liquid is selected from the group consisting of a silicon oxide film, a silicon nitride film, a silicon oxynitride film and a metal oxide film.

14. A drop discharging apparatus according to claim 8, wherein a pressure each of the plasma generating means and the drop discharging means is in a range of 1.3×10¹ to 1.31×10 Pa.

15. A drop discharging apparatus according to claim 8, wherein a contact angle θ of the surface having affinity for liquid is 0°≦θ<10°, and a contact angle θ of the liquid-repellent surface is 10°≦θ<180°.

16. A pattern forming method according to claim 2, wherein the drop composition is selected from the group consisting of a conductive material, a resist material, a polymer material and a light emitting material.

17. A pattern forming method according to claim 2, wherein a pressure each of the plasma generating means and the drop discharging means is in a range of 1.3×10¹ to 1.31×10⁵ Pa.

18. A pattern forming method according to claim 2, wherein a contact angle θ of the surface having affinity for liquid is 0°≦θ<10°, and a contact angle θ of the liquid-repellent surface is 10°≦0<180°.

19. A drop discharging apparatus according to claim 9, which has a structure in which the plasma generating means and the drop discharging means are integrated, or a structure in which a continuous process is possible.

20. A drop discharging apparatus according to claim 9, wherein the plasma generating means comprises an electrode on which a pair of solid dielectric material is installed, and a high frequency or a pulse power source which is introducing a process gas between electrodes.

21. A drop discharging apparatus according to claim 9, wherein a pressure each of the plasma generating means and the drop discharging means is in a range of 1.3×10¹ to 1.31×10⁵ Pa.

22. A drop discharging apparatus according to claim 9, wherein a contact angle 0 of the surface having affinity for liquid is 0°≦θ<10°, and a contact angle θ of the liquid-repellent surface is 10°≦θ<180°.
